(19) United States
(12) Patent Application Publication
(10) Pub. No.: US 2025/0310076 A1
(43) Pub. Date: Oct. 2, 2025

(54) Link Operations Based on Forwarded Clock Signal

(71) Applicant: Apple Inc., Cupertino, CA (US)

(72) Inventors: Haiming Jin, Cupertino, CA (US); Jacob S Schneider, San Diego, CA (US); Battaje Vimalesh Rao, San Marcos, CA (US); Philip Clovis, San Diego, CA (US); Hanan Cohen, San Diego, CA (US)

(21) Appl. No.: 18/617,479

(22) Filed: Mar. 26, 2024

(51) Int. Cl. H04L 7/00; H04L 7/02

(52) U.S. Cl. CPC H04L 7/0079; H04L 7/02

(57) ABSTRACT

This disclosure is generally directed to a full-duplex transceiver including a primary circuit and a secondary circuit communicating using a clock signal of the primary circuit (e.g., a single clock signal). The primary circuit may include circuitry to generate and/or forward the clock signal to the secondary circuit. The secondary circuit may sample received data using the clock signal. Moreover, the secondary circuit may generate data, perform data processing operations, and/or transmit data using the clock signal of the primary circuit.

### BACKGROUND

The present disclosure relates generally to a transceiver of an electronic device.

An electronic system or multiple electronic devices may communicate using transceivers. Each transceiver may include transmitters and receivers coupled via buses. As the electronic system communicates data with increased data rates, a signal quality of the communication signal between the transmitter and the receiver may undesirably decline.

### SUMMARY

This disclosure is generally directed to a full-duplex transceiver including a primary circuit and a secondary circuit communicating using a clock signal of the primary circuit (e.g., a single clock signal). The transceiver may couple a first circuit (e.g., a first chip) to a second circuit (e.g., a second chip). For example, the primary circuit of the transceiver may couple to the first circuit and the secondary circuit of the transceiver may couple to the second circuit. In some cases, the transceiver may communicate data between the first circuit and the second circuit using a clock signal associated with the first circuit.

The primary circuit may include circuitry to generate and/or forward the clock signal to the secondary circuit. The primary circuit may transmit first data based on a frequency of the clock signal to the secondary circuit. The secondary circuit may include circuitry to sample the first data using the clock signal. As such, the secondary circuit may sample the first data with reduced jitters, common-mode noises, and/or thermal noises based on using the clock signal of the primary circuit.

Moreover, the secondary circuit may include circuitry to generate data, perform data processing operations, and/or transmit data using the clock signal of the primary circuit. In some cases, the secondary circuit may synchronously transmit second data based on the clock signal. For example, the second data may be indicative of a request for transmission of the first data or third data to the primary circuit. In some cases, the secondary circuit may transmit the second data when receiving the first data and the clock signal.

In alternative or additional cases, the secondary circuit may transmit the second data when the primary circuit is idle and not transmitting the first data and/or the clock signal. In such cases, the secondary circuit may synchronously or asynchronously request for the clock signal for synchronous transmission of the second data. Moreover, the primary circuit may transmit the clock signal to the secondary circuit upon receiving the request. As such, the secondary circuit may transmit the second data using the clock signal. Accordingly, the primary circuit and the secondary circuit may communicate using the clock signal of the primary circuit. In some embodiments, the secondary circuit may occupy a reduced area and may consume reduced electrical power based on not including a dedicated clock generator.

### BRIEF DESCRIPTION OF THE DRAWINGS

Various aspects of this disclosure may be better understood upon reading the following detailed description and upon reference to the drawings in which:

FIG. 1 is a block diagram of an electronic device including clock circuitry, according to embodiments of the present disclosure;

FIG. 2 is a front view of a handheld device representing an example of the electronic device of FIG. 1, according to embodiments of the present disclosure;

FIG. 3 is a front view of another handheld device representing another example of the electronic device of FIG. 1, according to embodiments of the present disclosure;

FIG. 4 is a perspective view of a notebook computer representing an example of the electronic device of FIG. 1, according to embodiments of the present disclosure;

FIG. 5 illustrates front and side views of a wearable electronic device representing another example of the electronic device of FIG. 1, according to embodiments of the present disclosure;

FIG. 6 is a block diagram of a transceiver of the electronic device of FIGS. 1-5, according to embodiments of the present disclosure;

FIG. 7 is a circuit diagram of the transceiver of FIG. 6, according to embodiments of the present disclosure;

FIG. 8 is an example timing diagram of the transceiver of FIGS. 5 and 6 when a secondary circuit receives primary data from a primary circuit using a clock signal of the primary circuit, according to embodiments of the present disclosure; and

FIG. 9 is an example timing diagram of the transceiver of FIGS. 5 and 6 when the secondary circuit transmits secondary data to the primary circuit using the clock signal of the primary circuit, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

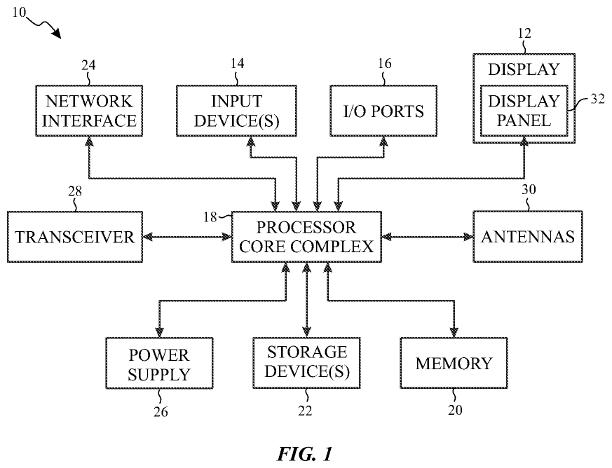

FIG. 1 is a block diagram of an electronic device 10 including an electronic display 12, according to embodiments of the present disclosure. As is described in more detail below, the electronic device 10 may be any suitable electronic device, such as a computer, a mobile phone, a portable media device, a tablet, a television, a virtual-reality headset, a wearable device such as a watch, a vehicle dashboard, or the like. Thus, it should be noted that FIG. 1 is merely one example of a particular implementation and is intended to illustrate the types of components that may be present in an electronic device 10.

The electronic device 10 includes the electronic display 12, one or more input devices 14, one or more input/output (I/O) ports 16, a processor core complex 18 having one or more processing circuitry(s) or processing circuitry cores, local memory 20, a main memory storage device 22, a network interface 24, a power source 26 (e.g., power supply), transceiver 28, and one or more antennas 30. The various components described in FIG. 1 may include hardware elements (e.g., circuitry), software elements (e.g., a tangible, non-transitory computer-readable medium storing executable instructions), or a combination of both hardware and software elements. It should be noted that the various depicted components may be combined into fewer components or separated into additional components. For example, the local memory 20 and the main memory storage device 22 may be included in a single component.

The processor core complex 18 is operably coupled with local memory 20 and the main memory storage device 22. Thus, the processor core complex 18 may execute instructions stored in local memory 20 and/or the main memory storage device 22 to perform operations, such as generating or transmitting image data to display on the electronic display 12. As such, the processor core complex 18 may include one or more processors, one or more general purpose microprocessors, one or more application specific integrated circuits (ASICs), one or more field programmable logic arrays (FPGAs), or any combination thereof. In some embodiments, a system on a chip (SoC) may include the processor core complex 18, among other things.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a Bluetooth network, a local area network (LAN), such as an 802.11x Wi-Fi network, or a wide area network (WAN), such as a 4G, Long-Term Evolution (LTE), or 5G cellular network.

The power source 26 may provide electrical power to one or more components in the electronic device 10, such as the processor core complex 18 or the electronic display 12. For example, the power source 26 may include a power supply rail and/or a ground terminal coupled to the one or more components in the electronic device 10, such as the processor core complex 18 or the electronic display 12, to provide the electrical power. Thus, the power source 26 may include any suitable source of energy, such as a rechargeable lithium polymer (Li-poly) battery or an alternating current (AC) power converter.

The transceiver 28 may include transmitters and receivers coupled via communication buses to transmit and receive data. The transceiver 28 may include a primary circuit coupled to a secondary circuit. In some embodiments, the transceiver 28 may include circuitry to transmit (e.g., forward) a clock signal of the primary circuit to the secondary circuit to perform one or more operations. As such, the secondary circuit may clock-in or sample received signals of the primary circuit, perform various operations, and/or transmit signals to the primary circuit using the clock signal of the primary circuit. For example, the secondary circuit may not include a clock circuit based on receiving the clock signal of the primary circuit. The primary circuit and/or the secondary circuit may each include and/or may be coupled to at least a part of the display 12, the input devices 14, the I/O ports 16, the processor core complex 18, the memory 20, the storage devices 22, the network interface 24, the power supply 26, and/or the antennas 30, among other things.

In some embodiments, the transceiver 28 may include circuitry for data communication using any version of a serializer and deserializer (SerDes) interface, a peripheral component interconnect express (PCIe) interface, or any other viable interfacing protocol, such as various communication standards. It should be appreciated that the transceiver 28 may include and/or utilize any viable circuitry to facilitate data communication between multiple circuits, components, chips, integrated circuits (ICs), and so on. For example, the transceiver 28 may be coupled to a first chip and a second chip to provide a chip-to-chip (C2C) interface. Moreover, it should be appreciated that the primary circuit and the secondary circuit of the transceiver 28 may communicate via a wired link (e.g., a bus) or a wireless link. For example, the transceiver 28 may use any viable communication protocol, such as Wi-Fi, 4G LTE, or 5G NR, among other possibilities, to establish and communicate using the wireless link.

The I/O ports 16 may enable the electronic device 10 to interface with other electronic devices. For example, when a portable storage device is connected, the I/O port 16 may enable the processor core complex 18 to communicate data with the portable storage device. The input devices 14 may enable user interaction with the electronic device 10, for example, by receiving user inputs via a button, a keyboard, a mouse, a trackpad, or the like. The input device 14 may include touch-sensing components in the electronic display 12. The touch sensing components may receive user inputs by detecting occurrence or position of an object touching the surface of the electronic display 12.

The electronic display 12 may include driver circuitry (e.g., display driver circuitry) and/or a display panel 32. The display panel 32 may include pixel circuitry with an array of display pixels. Moreover, the driver circuitry may include various circuitry to provide one or more stable positive and/or negative supply voltages, such the power supply rail and/or the ground terminal. Image data for display on the electronic display 12 may be generated by an image source, such as the processor core complex 18, a graphics processing unit (GPU), or an image sensor. Additionally, in some embodiments, image data may be received from another electronic device 10, for example, via the network interface 24 and/or an I/O port 16. Similarly, the electronic display 12 may display frames based on image data generated by the processor core complex 18, or the electronic display 12 may display frames based on image data received via the network interface 24, an input device, or an I/O port 16.

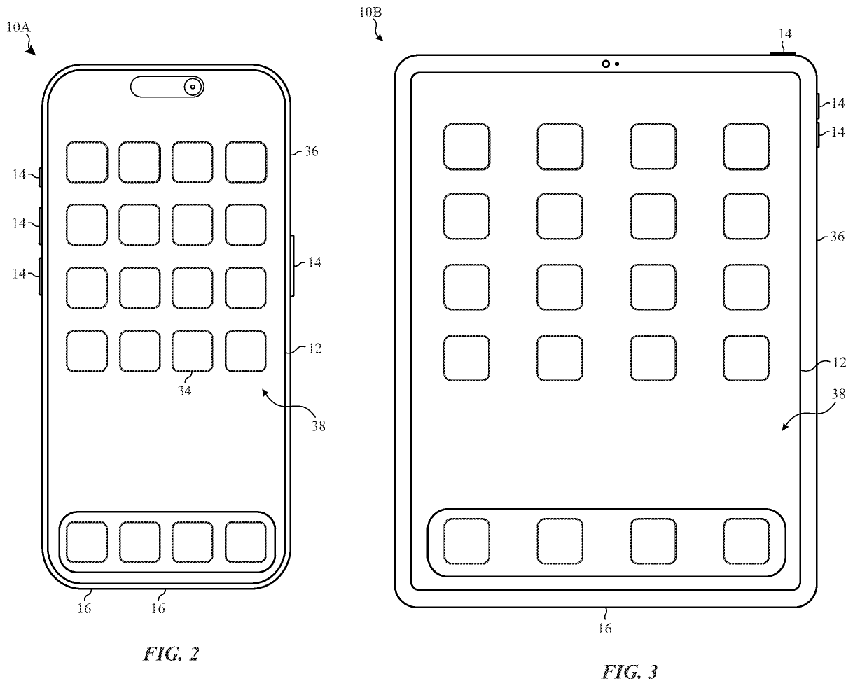

The electronic device 10 may also have the one or more antennas 30 electrically coupled to the processor core complex 18. The electronic device 10 may be any suitable electronic device. To help illustrate, an example of the electronic device 10, a handheld device 10A, is shown in FIG. 2. The handheld device 10A may be a portable phone, a media player, a personal data organizer, a handheld game platform, or the like. For illustrative purposes, the handheld device 10A may be a smart phone, such as any IPHONE® model available from Apple Inc.

The handheld device 10A includes an enclosure 36 (e.g., housing). The enclosure 36 may protect interior components from physical damage or shield them from electromagnetic interference, such as by surrounding the electronic display 12. The electronic display 12 may display a graphical user interface (GUI) 38 having an array of icons. When an icon 34 is selected either by an input device 14 or a touch-sensing component of the electronic display 12, an application program may launch.

The input devices 14 may be accessed through openings in the enclosure 36. The input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, or toggle between vibrate and ring modes.

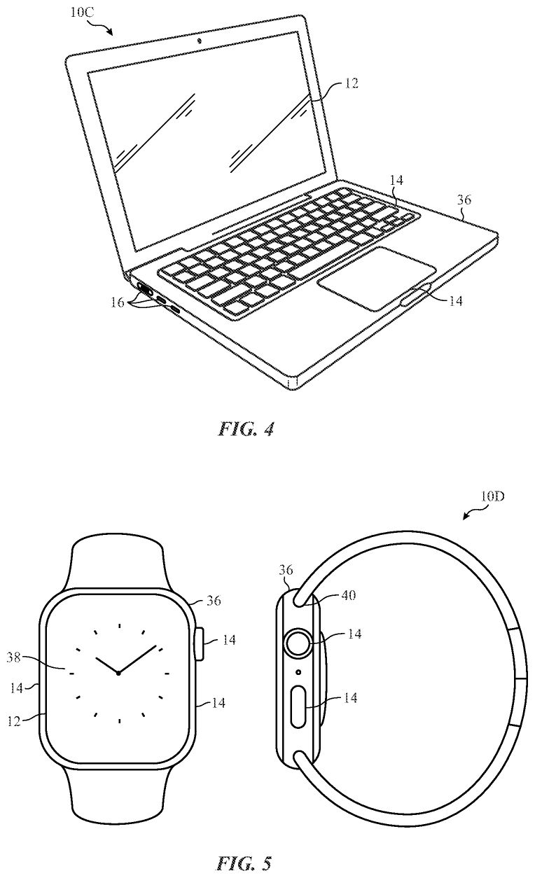

Another example of a suitable electronic device 10, specifically a tablet device 10B, is shown in FIG. 3. The tablet device 10B may be any IPAD® model available from Apple Inc. A further example of a suitable electronic device 10, specifically a computer 10C, is shown in FIG. 4. For illustrative purposes, the computer 10C may be any MACBOOK® or IMAC® model available from Apple Inc. Another example of a suitable electronic device 10, specifically a watch 10D, is shown in FIG. 5. For illustrative purposes, the watch 10D may be any APPLE WATCH® model available from Apple Inc.

As depicted, the tablet device 10B, the computer 10C, and the watch 10D each also includes an electronic display 12, input devices 14, I/O ports 16, and an enclosure 36. The electronic display 12 may display a GUI 38. As shown in FIG. 5, the GUI 38 may show a visualization of a clock. When the visualization is selected either by the input device 14 or a touch-sensing component of the electronic display 12, an application program may launch, such as to transition the GUI 38 to presenting the icons 34 discussed with respect to FIGS. 2 and 3.

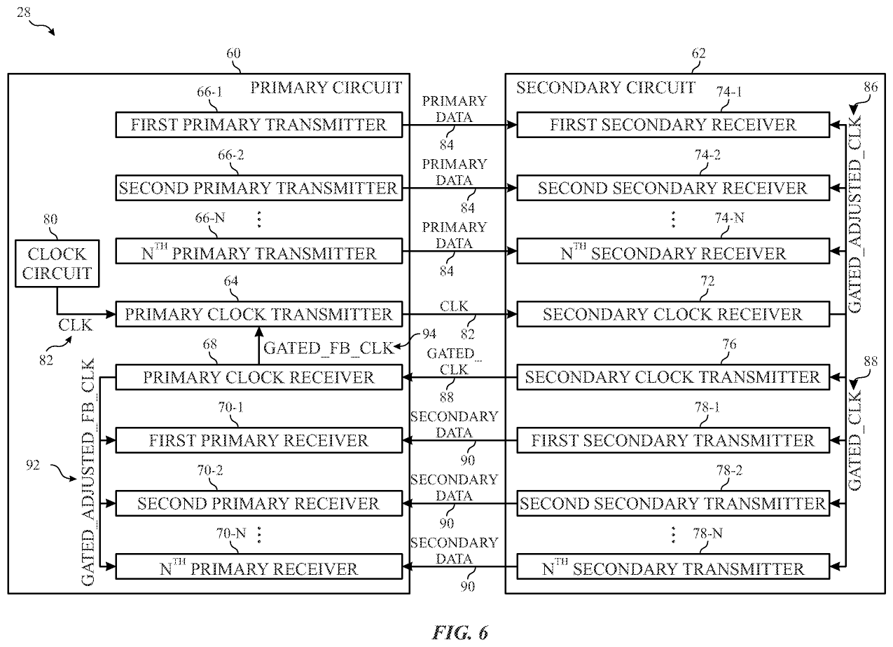

FIG. 6 is a block diagram of the transceiver 28 of the electronic device 10, according to embodiments of the present disclosure. The transceiver 28 may include a primary circuit 60 and a secondary circuit 62. The primary circuit 60 may include a primary clock transmitter 64, a first primary transmitter 66-1, a second primary transmitter 66-2, an N^{th} primary transmitter 66-N, a primary clock receiver 68, a first primary receiver 70-1, a second primary receiver 70-1, and an N^{th} primary receiver 70-N. Although three primary transmitters 66 and three primary receivers 70 are shown in FIG. 6, it should be appreciated that in different embodiments, the primary circuit 60 may include a different number of primary transmitters 66 and/or primary receivers 70.

The secondary circuit 62 may include a secondary clock receiver 72, a first secondary receiver 74-1, a second secondary receiver 74-2, an N^{th} secondary receiver 74-N, a secondary clock transmitter 76, a first secondary transmitter 78-1, a second secondary transmitter 78-2, and an N^{th} secondary transmitter 78-N. Although three secondary receivers 74 and three secondary transmitters 78 are shown in FIG. 6, it should be appreciated that in different embodiments, the secondary circuit 62 may include a different number of secondary receivers 74 and/or secondary transmitters 78.

With the foregoing in mind, the primary circuit 60 may include or may be coupled to a clock circuit 80. For example, in some embodiments, the primary circuit 60 may be coupled to the clock circuit 80 disposed on a first circuit (e.g., a first chip) separate from the primary circuit 60. Alternatively or additionally, the primary circuit 60 may be coupled to the clock circuit 80 disposed on the primary circuit 60.

The clock circuit 80 may include any viable circuit such as a crystal oscillator and/or a phase-locked loop (PLL), among other possibilities. The clock circuit 80 may generate and/or output a clock signal 82 (e.g., CLK) oscillating at a desired frequency and/or having a desired phase value. In some cases, the primary transmitters 66 may transmit primary data 84 to the respective secondary receivers 74 based on the clock signal 82 and/or using the frequency of the clock signal 82.

Moreover, the primary clock transmitter 64 may receive the clock signal 82. In some embodiments, the primary clock transmitter 64 may include circuitry to adjust a phase of the clock signal 82, generate in-phase and quadrature signals based on the clock signal 82, and/or adjust the frequency of the clock signal 82. The primary clock transmitter 64 may forward the clock signal 82 to the secondary circuit 62. In some embodiments, the secondary circuit 62 may not include a designated clock circuit for receiving the primary data 84 from the primary transmitters 66. For example, the secondary circuit 62 may be coupled to a second circuit (e.g., a second chip) communicating data with the primary circuit 60 and/or the first circuit (e.g., a first chip).

The secondary clock receiver 72 may include circuitry to adjust a phase of the clock signal 82, generate in-phase and quadrature signals based on the clock signal 82, and/or adjust the frequency of the clock signal 82. For example, the secondary clock receiver 72 may include clock settling circuitry to reduce a noise signal and/or undesired direct current (DC) signals of the clock signal 82. Moreover, the secondary clock receiver 72 may include a controlled delay line and/or a clock control circuit to adjust the phase of the clock signal 82. In some embodiments, the secondary clock receiver 72 may output an adjusted clock signal 86 (e.g., a gated and adjusted clock signal, GATED_ADJUSTED_CLK) and/or a gated clock signal 88 (e.g., GATED_CLK). In alternative or additional embodiments, the secondary clock receiver 72 may output one of the adjusted clock signal 86 or the gated clock signal 88.

In the depicted embodiment, the secondary receivers 74 may receive the adjusted clock signal 86. The secondary receivers 74 may sample the primary data 84 using the adjusted clock signal 86. Moreover, the secondary transmitters 78 may receive the gated clock signal 88. The secondary transmitters 78 may transmit secondary data 90 to the respective primary receivers 70 based on the adjusted clock signal 86 and/or using the frequency of the adjusted clock signal 86.

Furthermore, the secondary clock transmitter 76 may receive the gated clock signal 88. In some embodiments, the secondary clock transmitter 76 may include circuitry to adjust a phase of the gated clock signal 88, generate in-phase and quadrature signals based on the gated clock signal 88, and/or adjust the frequency of the gated clock signal 88. The secondary clock transmitter 76 may generate a feedback clock signal 82 (e.g., FB_CLK). The secondary clock transmitter 76 may output the feedback clock signal 82 to the primary circuit 60.

The primary clock receiver 68 may include circuitry to adjust a phase of the feedback clock signal 82, generate in-phase and quadrature signals based on the feedback clock signal 82, and/or adjust the frequency of the feedback clock signal 82. For example, the primary clock receiver 68 may include clock settling circuitry to reduce a noise signal and/or undesired DC signals of the feedback clock signal 82. Moreover, the primary clock receiver 68 may include a controlled delay line and/or a clock control circuit to adjust the phase of the feedback clock signal 82. In some embodiments, the primary clock receiver 68 may output an adjusted feedback clock signal 92 (e.g., a gated and adjusted feedback clock signal, GATED_ADJUSTED_FB_CLK) and/or a gated feedback clock signal 94 (e.g., GATED_FB_CLK).

In the depicted embodiment, the primary receivers 70 may receive the adjusted feedback clock signal 92. The primary receivers 70 may sample the secondary data 90 using the adjusted feedback clock signal 92. The primary clock transmitter 64 may receive the gated feedback clock signal 94. In some embodiments, the primary clock transmitter 64 may adjust the phase of the clock signal 82, generate the in-phase and quadrature signals, and/or adjust the frequency of the clock signal 82 based on the gated feedback clock signal 94.

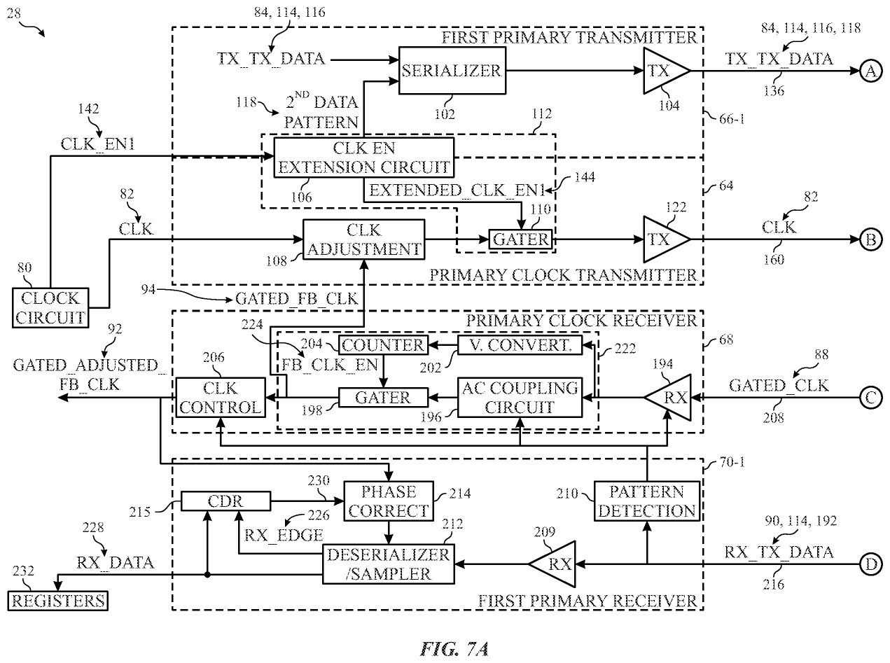

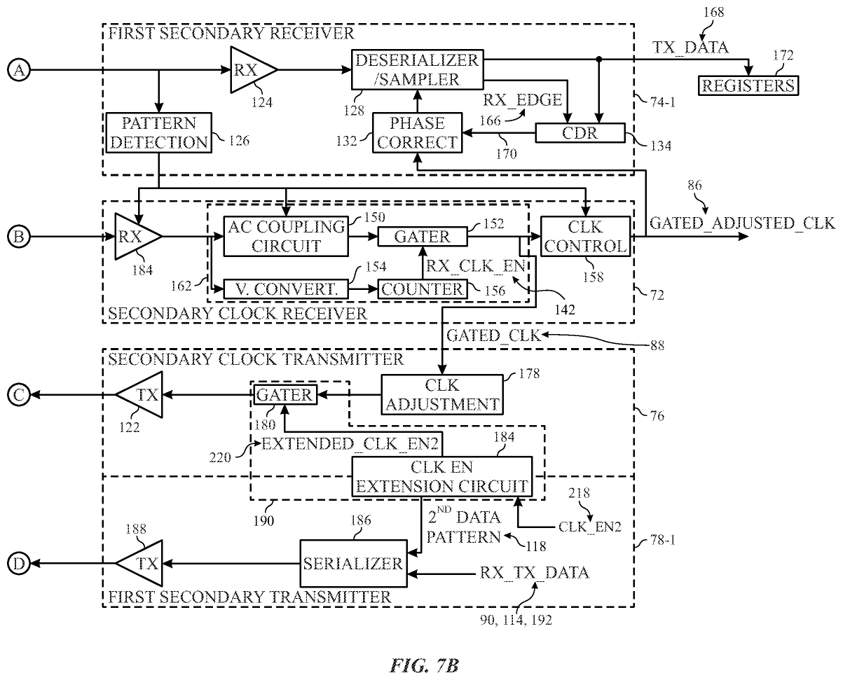

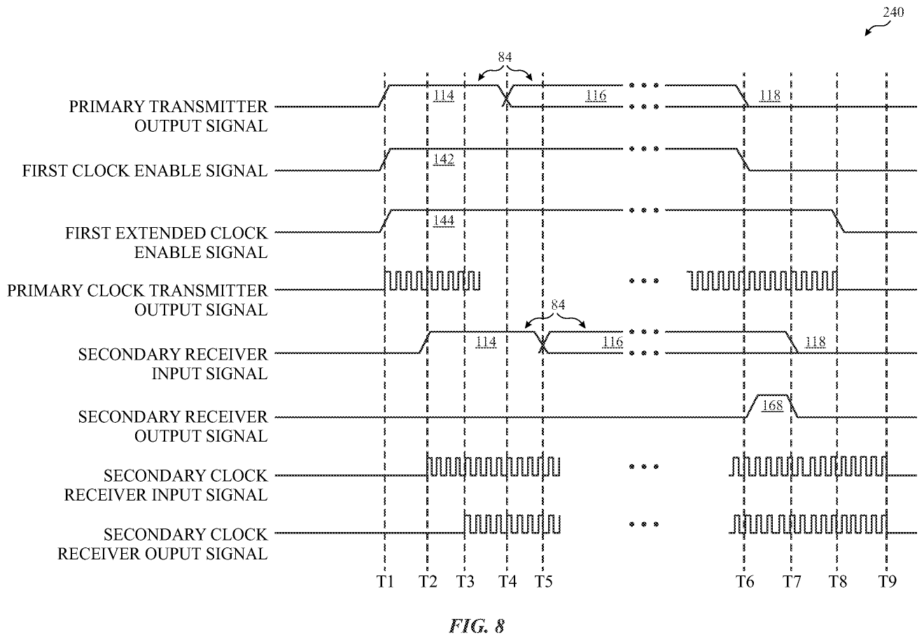

FIG. 7 is a circuit diagram of the transceiver 28 of the electronic device 10, according to embodiments of the present disclosure. The transceiver 28 may include the first primary transmitter 66-1, the primary clock transmitter 64, the primary clock receiver 68, the first primary receiver 70-1, the clock circuit 80, the first secondary receiver 74-1, the secondary clock receiver 72, the secondary clock transmitter 76, and the first secondary transmitter 78-1. It should be appreciated that in different embodiments, the transceiver 28 may include a different number of the primary transmitters 66, the primary receivers 70, the secondary receivers 74, and/or the secondary transmitters 78.

Moreover, it should be appreciated that embodiments discussed herein with respect to the first primary transmitter 66-1, the first primary receiver 70-1, the first secondary receiver 74-1, and the first secondary transmitter 78-1 may additionally or alternatively be associated with and/or correspond to embodiments of the second primary transmitter 66-2 and the N^{th} primary transmitter 66-N, the second primary receiver 70-1 and the N^{th} primary receiver 70-N, the second secondary receiver 74-2 and the N^{th} secondary receiver 74-N, and the second secondary transmitter 78-2 and the N^{th} secondary transmitter 78-N, respectively.

The clock circuit 80 may be coupled to the primary clock transmitter 64 and/or the first primary transmitter 66-1. The first primary transmitter 66-1 may include first serializer circuitry 102, a first transmission amplifier 104, and/or the first clock enable extension circuit 106. The primary clock transmitter 64 may include a primary clock adjustment circuit 108, a first gater 110, a second transmission amplifier 122, and/or the first clock enable extension circuit 106.

In specific embodiments, the primary clock transmitter 64 may include the clock circuit 80. In different embodiments, the first clock enable extension circuit 106 may be disposed on the primary clock transmitter 64, the first primary transmitter 66-1, or both. For example, the first primary transmitter 66-1 and/or the primary clock transmitter 64 may each include a respective portion of the first clock enable extension circuit 106. Moreover, the first clock enable extension circuit 106 and the first gater 110 may form first clock extension circuitry 112.

The first serializer circuitry 102 may receive the primary data 84 (e.g., TX_TX_DATA). Any viable circuitry and/or components may provide the primary data 84 to the first serializer circuitry 102. In specific embodiments, the processor core complex 18 of the electronic device 10 may generate and/or output the primary data 84. The primary data 84 may include a first data pattern 114 (e.g., a PREP pattern) followed by first synchronization data and/or payload 116. The first data pattern 114 may be indicative of a start of a primary data transmission period. In some embodiments, the processor core complex 18 may generate and/or output the payload 116 to the secondary circuit 62 in response to a synchronous or asynchronous request for a burst of data (e.g., the payload 116). For example, a secondary transmitter 78 or a peripheral device coupled to the secondary circuit 62 may generate the request. The payload 116 may include structured or unstructured data, image data, instructions, among other possibilities.

Moreover, the first serializer circuitry 102 may receive a second data pattern 118 (e.g., a zero padding pattern, an idle mode data pattern). In the depicted embodiment, the first clock enable extension circuit 106 may generate and/or output the second data pattern 118. The second data pattern 118 may be indicative of a termination of the primary data transmission period. For example, the first secondary receiver 74-1 may clock-in or sample the first synchronization data and/or payload 116 of the primary data 84 during the primary data transmission period. Moreover, the first secondary receiver 74-1 may detect the primary data transmission period based on the first data pattern 114 and the second data pattern 118.

The first serializer circuitry 102 may output the primary data 84 followed by the second data pattern 118 to the first transmission amplifier 104. The first serializer circuitry 102 may include circuitry (e.g., a multiplexer) to selectively output the second data pattern 118 after outputting the primary data 84. In some embodiments, the first serializer circuitry 102 may include circuitry to receive the primary data 84 and/or the second data pattern 118 in parallel form, convert the parallel primary data 84 and/or second data pattern 118 to serial form, and output the primary data 84 and/or the second data pattern 118 to the first transmission amplifier 104 in serial form.

The first transmission amplifier 104 may output the primary data 84 and the second data pattern 118 to the first secondary receiver 74-1. In some embodiments, the first transmission amplifier 104 may amplify a current and/or a voltage of the primary data 84 and/or the second data pattern 118 before the transmission. The first primary transmitter 66-1 may transition to an idle mode when the first transmission amplifier 104 outputs the second data pattern 118 to the first secondary receiver 74-1. For example, the first primary transmitter 66-1 may not transmit data when in idle mode.

The first secondary receiver 74-1 may include a first reception amplifier 124, a first pattern detection circuit 126, first deserializer and sampler circuitry 128, a first phase correction circuit 132, and a first clock-domain recovery (CDR) circuit 134. In the depicted embodiment, the first transmission amplifier 104 may be coupled to the first reception amplifier 124 and the first pattern detection circuit 126 via a first bus 136 (e.g., a link). The first deserializer and sampler circuitry 128 may include a deserializer circuit and a sampler circuit.

The first reception amplifier 124 and the first pattern detection circuit 126 may receive the primary data 84 and the second data pattern 118. The first pattern detection circuit 126 may detect the first data pattern 114 and the second data pattern 118. As mentioned above, the first data pattern 114 may be indicative of the start of the primary data transmission period. The first pattern detection circuit 126 may activate the secondary clock receiver 72 in response to the first data pattern 114 and deactivate the secondary clock receiver 72 in response to the second data pattern 118.

As discussed above, in some embodiments, the transceiver 28 may include the second primary transmitter 66-2, the N^{th} primary transmitter 66-N, the second secondary receiver 74-2, and/or the N^{th} secondary receiver 74-N (not shown for simplicity). In some embodiments, the second primary transmitter 66-2 and the N^{th} primary receiver 70-N may each include similar circuitry compared to the first primary transmitter 66-1. Moreover, the second secondary receiver 74-2 and the N^{th} secondary receiver 74-N may each include similar circuitry compared to the first secondary receiver 74-1. For example, the second secondary receiver 74-2 and the N^{th} secondary receiver 74-N may be coupled to the second primary transmitter 66-2 and the N^{th} primary transmitter 66-N, respectively.

Moreover, the respective second pattern detection circuits of the secondary receivers 74-1, 74-2, and/or 74-N may each activate the secondary clock receiver 72 in response to the first data pattern 114. Moreover, the respective second pattern detection circuits may each provide an indication to deactivate the secondary clock receiver 72 in response to the second data pattern 118. As such, the secondary clock receiver 72 may become deactivated in response to the first secondary receiver 74-1, the second secondary receiver 74-2, and/or the N^{th} secondary receiver 74-N being deactivated or outputting the indication to deactivate the primary clock receiver 68.

In any case, the secondary clock receiver 72 may receive the clock signal 82 from the primary clock transmitter 64 when activated. The secondary clock receiver 72 may output the adjusted clock signal 86 and/or the gated clock signal 88 when activated and while receiving the clock signal 82. Moreover, the first secondary receiver 74-1 may clock-in or sample the first synchronization data and/or payload 116 of the primary data 84 based on the clock signal 82, the adjusted clock signal 86, and/or gated clock signal 88, as will be appreciated.

With the foregoing in mind, the clock circuit 80 may include any viable circuit to generate the clock signal 82. The primary clock adjustment circuit 108 may receive the clock signal 82. In some embodiments, the primary clock adjustment circuit 108 may include circuitry to adjust a phase of the clock signal 82, generate in-phase and quadrature signals based on the clock signal 82, and/or adjust the frequency of the clock signal 82. The primary clock adjustment circuit 108 may output the clock signal 82 to the first gater 110.

The clock circuit 80 may also generate a first clock enable signal 142 during a time associated with the first serializer circuitry 102 receiving the primary data 84. In some cases, the clock circuit 80 may output the first clock enable signal 142 while the first serializer circuitry 102 is receiving the primary data 84. In specific cases, the clock circuit 80 may output the first clock enable signal 142 for an amount of time associated with receiving and/or transmitting the primary data 84 by the first primary transmitter 66-1.

The first clock enable extension circuit 106 may receive the first clock enable signal 142. The first clock enable extension circuit 106 may output a first extended clock enable signal 144 (EXTENDED_CLK_EN1) to the first gater 110 based on receiving the first clock enable signal 142. The first clock enable extension circuit 106 may output the first extended clock enable signal 144 for an extended amount of time compared to the amount of time associated with receiving the first clock enable signal 142.

In some cases, the first clock enable extension circuit 106 may output the first extended clock enable signal 144 when receiving the first clock enable signal 142 and during an extended (or additional) time after the first clock enable signal 142 is received. The extended amount of time may be associated with additional time or additional number of clock cycles for the first secondary receiver 74-1 to sample or clock-in the primary data 84 after the first primary transmitter 66-1 transmits the primary data 84. In some cases, the extended amount of time may be associated with pipe cleaning the first secondary receiver 74-1 after receiving the primary data 84. Pipe cleaning may be associated with clocking-in, sampling, amplifying, latching, and/or outputting the data bits being received, or any combination thereof, among other possibilities. As mentioned above, the first clock enable extension circuit 106 may also output the second data pattern 118 to the first serializer circuitry 102.

In some embodiments, the first clock enable extension circuit 106 may output at least a portion of the second data pattern 118 during the additional time or the additional number of clock cycles. That is, in such embodiments, the first clock enable extension circuit 106 may output at least a portion of the second data pattern 118 when outputting the first extended clock enable signal 144 and when the first clock enable signal 142 is removed. Alternatively or additionally, the first clock enable extension circuit 106 may output at least a portion of the second data pattern 118 after the first extended clock enable signal 144 is removed.

As discussed above, the first gater 110 may receive the clock signal 82 and the first extended clock enable signal 144. The first gater 110 may output (e.g., forward, pass-through) the clock signal 82, as adjusted by the primary clock adjustment circuit 108, to the second transmission amplifier 122 based on receiving the first extended clock enable signal 144. For example, the first gater 110 may output the clock signal 82 to the second transmission amplifier 122 while receiving the first extended clock enable signal 144. Moreover, the first gater 110 may not output the clock signal 82 when the first extended clock enable signal 144 is removed. In some embodiments, the first gater 110 may output the clock signal 82 by reducing a noise signal and/or undesired DC signals of the clock signal 82.

The second transmission amplifier 122 may output the clock signal 82 to the secondary clock receiver 72. In particular, the second transmission amplifier 122 may output the clock signal 82 based on (e.g., during) the extended amount of time associated with the first extended clock enable signal 144. In some cases, the second transmission amplifier 122 may amplify a current and/or a voltage of the clock signal 82 to transmit an amplified clock signal 82 to the secondary clock receiver 72. The secondary clock receiver 72 may receive the clock signal 82 when activated. As mentioned above, the first pattern detection circuit 126 may activate the secondary clock receiver 72 in response to detecting the first data pattern 114.

As such, the secondary clock receiver 72 may receive the clock signal 82 in response to the first secondary receiver 74-1, or any other secondary receiver 74 (not shown for simplicity), receiving the first data pattern 114. In some cases, the first data pattern 114 may be indicative of a respective primary data 84 being received subsequently. Alternatively or additionally, the first data pattern 114 may be associated with providing the clock signal 82 to the secondary circuit 62 in response to a synchronous or asynchronous request for the clock signal 82 from a secondary transmitter 78.

In the depicted embodiment, the secondary clock receiver 72 may generate and output the adjusted clock signal 86 and the gated clock signal 88 based on receiving the clock signal 82 when activated. Alternatively or additionally, the secondary clock receiver 72 may output the clock signal 82. The secondary clock receiver 72 may include a second reception amplifier 148, a first AC coupling circuit 150, a second gater 152, a first voltage converter 154, a first counter 156, and a first clock control circuit 158. In the depicted embodiment, the second transmission amplifier 122 of the primary clock transmitter 64 may be coupled to the second reception amplifier 148 of the secondary clock receiver 72 via a second bus 160.

In some cases, the first primary transmitter 66-1 may output the first data pattern 114 at a time or near a time the primary clock transmitter 64 outputs the clock signal 82. The first pattern detection circuit 126 may activate the second reception amplifier 148 at a time, near the time, or before the time the second reception amplifier 148 receives the clock signal 82. In specific cases, the first bus 136 and the second bus 160 may delay transporting the data and/or the clock signal 82 based on (e.g., at, after) a first time delay.

Moreover, the first pattern detection circuit 126, or pattern detection circuits of any other secondary receiver 74 (not shown), may activate the secondary clock receiver 72 based on receiving the first data pattern 114. In the depicted embodiment, the first pattern detection circuit 126 may activate the second reception amplifier 148, the first AC coupling circuit 150, the second gater 152, or any combination thereof. When activated, the second reception amplifier 148 may receive and provide the clock signal 82 to the first AC coupling circuit 150 and the first voltage converter 154. In some cases, the second reception amplifier 148 may amplify a current and/or a voltage of the clock signal 82 to output an amplified clock signal 82.

The first AC coupling circuit 150, the second gater 152, the first voltage converter 154, and the first counter 156 may form first clock settling circuitry 162. In some embodiments, the first AC coupling circuit 150 may include one or more capacitors. The first AC coupling circuit 150 may reduce undesired common-mode signals and/or undesired DC signals of the clock signal 82. If not compensated for, in some cases, the clock signal 82 may exhibit jitter and noise upon initial reception by the first AC coupling circuit 150. As such, the first clock settling circuitry 162 may disregard a number of clock cycles of the clock signal 82 upon initial reception of the clock signal 82, as will be appreciate. Accordingly, the first clock settling circuitry 162 may improve the signal integrity of the received clock signal 82. For example, the number of the clock cycles may correspond to a settling time of the first AC coupling circuit 150.

The first AC coupling circuit 150 may output the clock signal 82, as adjusted, to the second gater 152. In some cases, the first AC coupling circuit 150 may output a stabilized clock signal 82 based on (e.g., at or after) the settling time upon reception of the clock signal 82. For example, the first AC coupling circuit 150 may output one or more clock cycles with higher than a threshold voltage, phase, and/or frequency variation during the settling time and upon reception of the clock signal 82. Moreover, the first AC coupling circuit 150 may output a stabilized clock signal 82 after the settling time.

The first voltage converter 154 may adjust a voltage level (e.g., logic level) of the clock signal 82. In some embodiments, the first voltage converter 154 may receive the clock signal 82 with a first voltage level and output the clock signal 82 with a second voltage level. For example, the primary clock transmitter 64 may transmit the clock signal 82 using current mode logic (CML) signaling based on voltage swings on a current level (e.g., constant current level). Moreover, the first voltage converter 154 may convert the clock signal 82 to a square wave signal with a voltage level of the secondary clock receiver 72, such as a Complementary Metal-Oxide-Semiconductor (CMOS) voltage level. Alternatively or additionally, the first voltage converter 154 may receive the clock signal 82 with a different voltage level or signaling and output the clock signal 82 with a different voltage level or signaling.

The first voltage converter 154 may output the clock signal 82, as adjusted, to the first counter 156. The first counter 156 may disregard a number of clock cycles of the clock signal 82 upon reception of the clock signal 82. The number of clock cycles may be associated with the settling time of the first AC coupling circuit 150.

In different cases, the primary clock transmitter 64 may output the clock signal 82 with a different frequency. For example, the frequency of the clock signal 82 may be predetermined and/or programmable. Moreover, the frequency of the clock signal 82 may correspond to the settling time of the first AC coupling circuit 150. The number of clock cycles may be predetermined and/or programmable, for example, based on the frequency of the clock signal 82. As such, the first counter 156 may be programmable, dynamically or during manufacturing, to disregard a different number of clock cycles of the clock signal 82, upon reception of the clock signal 82, based on the frequency of the clock signal 82.

In any case, the first counter 156 may output a first receiver clock enable signal 142 (RX_CLK_EN) after disregarding the number of clock cycles upon reception of the clock signal 82. The first counter 156 may remove the first receiver clock enable signal 142 when the clock signal 82 is removed. As mentioned above, the primary clock transmitter 64 may output the clock signal 82 based on the extended amount of time of the first extended clock enable signal 144. As such, in some cases, the first counter 156 may output the first receiver clock enable signal 142 during a first time duration less than the extended amount of time of the first extended clock enable signal 144 by disregarding the number of clock cycles based on the settling time of the first AC coupling circuit 150.

The first counter 156 may output the first receiver clock enable signal 142 to the second gater 152. As such, the second gater 152 may receive the clock signal 82 and the first receiver clock enable signal 142. The first counter 156 may output the first receiver clock enable signal 142 based on a second time delay compared to a reception time of the clock signal 82 by the secondary clock receiver 72. The second time delay may be based on disregarding the number of clock cycles based on the settling time of the first AC coupling circuit 150.

The second gater 152 may output (e.g., forward, pass-through) a gated clock signal 88 based on receiving the first receiver clock enable signal 142. For example, the second gater 152 may output the gated clock signal 88 while receiving the first receiver clock enable signal 142. Moreover, the second gater 152 may not output the gated clock signal 88 when the first receiver clock enable signal 142 is removed. In some embodiments, the second gater 152 may output the gated clock signal 88 by reducing a noise signal and/or undesired DC signals of the clock signal 82. As such, the first clock settling circuitry 162 may output the gated clock signal 88 after the second time delay compared to the reception time of the clock signal 82.

The second gater 152 may output the gated clock signal 88 to the first clock control circuit 158 and the secondary clock transmitter 76. In some embodiments, the first clock control circuit 158 may include a digital clock control circuit, a digitally controlled delay line, a phase interpolator, a gater, or any combination thereof, among other things. The first clock control circuit 158 may adjust a phase of the gated clock signal 88, generate in-phase and quadrature signals based on the gated clock signal 88, and/or adjust the frequency of the gated clock signal 88. The first clock control circuit 158 may generate the adjusted clock signal 86. In the depicted embodiment, the first clock control circuit 158 may output the adjusted clock signal 86 to the first phase correction circuit 132. Alternatively or additionally, the first clock control circuit 158 may output the adjusted clock signal 86 to any other viable circuitry.

As discussed above, the primary clock transmitter 64 may output the clock signal 82 based on the extended amount of time of the first extended clock enable signal 144. Moreover, the first clock enable extension circuit 106 may output the first extended clock enable signal 144 when receiving the first clock enable signal 142 from the clock circuit 80 and during an extended (or additional) time after the first clock enable signal 142 is received. In some embodiments, the extended amount of time may include at least a portion of the first time delay associated with the first bus 136 and the second bus 160 transporting the data and/or the clock signal 82.

Additionally or alternatively, the extended amount of time may include at least a portion of the second time delay associated with stabilizing the clock signal 82 based on the settling time of the first AC coupling circuit 150. Additionally or alternatively, the extended amount of time may include at least a portion of the additional time or additional number of clock cycles for the first secondary receiver 74-1 to sample or clock-in the primary data 84 after the first primary transmitter 66-1 transmits the primary data 84. For example, the first secondary receiver 74-1 may clock-in or sample the primary data 84 using the clock cycles received during reception of the primary data 84 and additional clock cycles after receiving the entirety of the primary data 84.

Referring back to the first secondary receiver 74-1, the first reception amplifier 124 may receive and provide (e.g., forward, pass-through) the primary data 84 followed by the second data pattern 118. As mentioned above, the primary data 84 may include the first data pattern 114 and the first synchronization data and/or payload 116. In some cases, the first reception amplifier 124 may amplify a current and/or a voltage of the input signals to output amplified primary data 84 and/or amplified second data pattern 118.

The first deserializer and sampler circuitry 128 may receive the primary data 84 followed by the second data pattern 118. In some embodiments, the first deserializer and sampler circuitry 128 may include circuitry to receive the primary data 84 and/or the second data pattern 118 in serial form, convert the serial primary data 84 and/or the serial second data pattern 118 to parallel form, and output the primary data 84 and/or the second data pattern 118 in parallel form. In some embodiments, the first deserializer and sampler circuitry 128 may include circuitry to sample or clock-in the primary data 84 and the second data pattern 118.

The first secondary receiver 74-1 may detect the primary data transmission period based on the first data pattern 114 and the second data pattern 118. For example, the first secondary receiver 74-1 may transition to an active mode based on receiving the first data pattern 114. The first deserializer and sampler circuitry 128 may detect or generate a transmission data edge signal 166 (e.g., TX_EDGE) and a transmission payload 168 (e.g., TX_DATA) based on receiving the primary data 84 and/or the second data pattern 118. The transmission data edge signal 166 may have an oscillation pattern (e.g., signal edges) based on a frequency and/or phases of the primary data 84 and/or the second data pattern 118. The first deserializer and sampler circuitry 128 may output the transmission data edge signal 166 and the transmission payload 168 to the first CDR circuit 134.

In some embodiments, the first CDR circuit 134 may generate first clock recovery signal 170 based on the transmission data edge signal 166 and the transmission payload 168. The first clock recovery signal 170 may include a clock signal having a frequency and/or phases corresponding to the frequency and/or phases of the primary data 84 and/or the second data pattern 118. The first phase correction circuit 132 may receive the first clock recovery signal 170 from the first CDR circuit 134. Moreover, the first phase correction circuit 132 may receive the adjusted clock signal 86 from the first clock control circuit 158.

The first phase correction circuit 132 may include a digital clock control circuit, a digitally controlled delay line, a phase interpolator, a gater, or any combination thereof, among other things. The first phase correction circuit 132 may adjust a phase of the adjusted clock signal 86, generate in-phase and quadrature signals of the adjusted clock signal 86, and/or adjust the frequency of the adjusted clock signal 86 based on the first clock recovery signal 170. The first phase correction circuit 132 may provide the adjusted clock signal 86, as adjusted, to the first deserializer and sampler circuitry 128.

Accordingly, the first deserializer and sampler circuitry 128 may sample or clock-in the primary data 84 and the second data pattern 118 based on the adjusted clock signal 86, as adjusted based on a frequency and/or phase of previously received primary data 84 and/or previously received second data pattern 118. In some cases, the first deserializer and sampler circuitry 128 may detect the transmission payload 168 by sampling or clocking-in the primary data 84 based on the adjusted clock signal 86. In some embodiments, the first deserializer and sampler circuitry 128 may detect the transmission payload 168 based on instructions received with the synchronization data of the first synchronization data and/or payload 116.

The transmission payload 168 may include data indicative of an operation, data for display on the display 12 of the electronic device 10, and/or data for storage on the memory 20 and/or the storage devices 22, among other possibilities. In the depicted embodiment, secondary registers 172 of the secondary circuit 62 may store the transmission payload 168. For example, the memory 20 and/or the storage devices 22 of the electronic device 10 may include the secondary registers 172.

The first deserializer and sampler circuitry 128 may receive the second data pattern 118 after the primary data 84. As mentioned above, the second data pattern 118 may be indicative of a termination of the primary data transmission period. For example, the first deserializer and sampler circuitry 128 may detect or generate the transmission payload 168 based on receiving the primary data 84 during the primary data transmission period.

Moreover, the first deserializer and sampler circuitry 128 may become idle based on receiving the second data pattern 118. In some cases, the first pattern detection circuit 126 and/or the first deserializer and sampler circuitry 128 may snoop for a subsequent first data pattern 114 and/or a subsequent first synchronization data and/or payload 116 when in idle mode. Moreover, the first deserializer and sampler circuitry 128 may become activated based on receiving the subsequent first data pattern 114 and/or the subsequent first synchronization data and/or payload 116 when in the idle mode.

The secondary clock transmitter 76 may include a secondary clock adjustment circuit 178, a third gater 180, a third transmission amplifier 182, and/or a second clock enable extension circuit 184. The first secondary transmitter 78-1 may include second serializer circuitry 186, a fourth transmission amplifier 188, and/or the second clock enable extension circuit 184. In different embodiments, the second clock enable extension circuit 184 may be disposed on the secondary clock transmitter 76, the first secondary transmitter 78-1, or both.

For example, the first secondary transmitter 78-1 and/or the secondary clock transmitter 76 may each include a respective portion of the second clock enable extension circuit 184. Moreover, the second clock enable extension circuit 184 and the third gater 180 may form second clock extension circuitry 190. In some embodiments, the second clock enable extension circuit 184 may include similar circuitry compared to the first clock enable extension circuit 106. The second clock enable extension circuit 184 and the third gater 180 may form second clock enable extension circuitry 184.

The second serializer circuitry 186 may receive the secondary data 90 (e.g., RX_TX_DATA). Any viable circuitry and/or components may provide the secondary data 90 to the second serializer circuitry 186. In specific embodiments, the processor core complex 18, the memory 20, the storage devices 22, the display 12, and/or the antenna 30 of the electronic device 10, among other things, may generate and/or output the secondary data 90. The secondary data 90 may include the first data pattern 114 (e.g., a PREP pattern) followed by second synchronization data and/or payload 192. The first data pattern 114 may be indicative of a start of a secondary data transmission period. In some embodiments, an electronic device coupled to the secondary circuit 62 may generate and/or output the payload 192 in response to a synchronous or asynchronous request for a burst of data (e.g., the payload 192). The primary circuit 60 or the processor core complex 18 coupled to the primary circuit 60 may generate the request. The payload 192 may include structured or unstructured data, image data, instructions, among other possibilities.

Moreover, the second serializer circuitry 186 may receive the second data pattern 118. In the depicted embodiment, the second clock enable extension circuit 184 may generate and/or output the second data pattern 118. The second data pattern 118 may be indicative of a termination of a secondary data transmission period. For example, the first primary receiver 70-1 may clock-in or sample the second synchronization data and/or payload 192 of the secondary data 90 during the secondary data transmission period. Moreover, the first primary receiver 70-1 may detect the secondary data transmission period based on the first data pattern 114 and the second data pattern 118.

The second serializer circuitry 186 may output the secondary data 90 followed by the second data pattern 118 to the fourth transmission amplifier 188. The second serializer circuitry 186 may include circuitry (e.g., a multiplexer) to selectively output the second data pattern 118 after outputting the secondary data 90. In some embodiments, the second serializer circuitry 186 may include circuitry to receive the secondary data 90 and/or the second data pattern 118 in parallel form, convert the parallel secondary data 90 and/or second data pattern 118 to serial form, and output the secondary data 90 and/or the second data pattern 118 to the fourth transmission amplifier 188 in serial form. The fourth transmission amplifier 188 may output the secondary data 90 and the second data pattern 118 to the first primary receiver 70-1. In some embodiments, the fourth transmission amplifier 188 may amplify a current and/or a voltage of the secondary data 90 and/or the second data pattern 118 before the transmission.

The primary clock receiver 68 may include a third reception amplifier 194, a second AC coupling circuit 196, a fourth gater 198, a second voltage converter 202, a second counter 204, and a second clock control circuit 206. In the depicted embodiment, the third transmission amplifier 182 of the secondary clock transmitter 76 may be coupled to the third reception amplifier 194 of the primary clock receiver 68 via a third bus 208.

The first primary receiver 70-1 may include a fourth reception amplifier 209, a second pattern detection circuit 210, second deserializer and sampler circuitry 212, a second phase correction circuit 214, and a second CDR circuit 215. In the depicted embodiment, the fourth transmission amplifier 188 may be coupled to the fourth reception amplifier 209 and the second pattern detection circuit 210 via a fourth bus 216. The second deserializer and sampler circuitry 212 may include a deserializer circuit and a sampler circuit.

The fourth reception amplifier 209 and the second pattern detection circuit 210 may receive the secondary data 90 and the second data pattern 118. The second pattern detection circuit 210 may detect the first data pattern 114 and the second data pattern 118. As mentioned above, the first data pattern 114 may be indicative of the start of the secondary data transmission period. The second pattern detection circuit 210 may activate the primary clock receiver 68 in response to the first data pattern 114 and deactivate the primary clock receiver 68 in response to the second data pattern 118.

As discussed above, in some embodiments, the transceiver 28 may include the second secondary transmitter 78-2, the N^{th} secondary transmitter 78-N, the second primary receiver 70-1, and/or the N^{th} primary receiver 70-N (not shown for simplicity). In some embodiments, the second secondary transmitter 78-2 and the N^{th} primary receiver 70-N may each include similar circuitry compared to the first secondary transmitter 78-1. Moreover, the second primary receiver 70-1 and the N^{th} primary receiver 70-N may each include similar circuitry compared to the first primary receiver 70-1. For example, the second primary receiver 70-1 and the N^{th} primary receiver 70-N may be coupled to the second secondary transmitter 78-2 and the N^{th} secondary transmitter 78-N, respectively.

Moreover, the respective second pattern detection circuits of the primary receivers 70-1, 70-2, and/or 70-N may each activate the primary clock receiver 68 in response to the first data pattern 114. Moreover, the respective second pattern detection circuits may each provide an indication to deactivate the primary clock receiver 68 in response to the second data pattern 118. As such, the primary clock receiver 68 may become deactivated in response to the first primary receiver 70-1, the second primary receiver 70-1, and/or the N^{th} primary receiver 70-N being deactivated or outputting the indication to deactivate the primary clock receiver 68.

In any case, the primary clock receiver 68 may receive the gated clock signal 88 from the secondary clock transmitter 76 when activated. The primary clock receiver 68 may output an adjusted feedback clock signal 92 and/or a gated feedback clock signal 94 when activated and while receiving the gated clock signal 88. Moreover, the first primary receiver 70-1 may clock-in or sample the second synchronization data and/or payload 192 of the secondary data 90 based on the gated clock signal 88, the adjusted feedback clock signal 92 and/or gated feedback clock signal 94, as will be appreciated.

With the foregoing in mind, the secondary clock adjustment circuit 178 may receive the gated clock signal 88. In some embodiments, the secondary clock adjustment circuit 178 may include circuitry to adjust a phase of the gated clock signal 88, generate in-phase and quadrature signals based on the gated clock signal 88, and/or adjust the frequency of the gated clock signal 88. The secondary clock adjustment circuit 178 may output the gated clock signal 88 to the third gater 180.

The second clock enable extension circuit 184 may receive a second clock enable signal 218. Any viable circuitry and/or components may generate the second clock enable signal 218 during a time associated with the second serializer circuitry 186 receiving the secondary data 90. In specific embodiments, the processor core complex 18, the memory 20, the storage devices 22, the display 12, and/or the antenna 30 of the electronic device 10, among other things, may generate and/or output the second clock enable signal 218.

In some cases, the second clock enable extension circuit 184 may receive the second clock enable signal 218 while the second serializer circuitry 186 is receiving the secondary data 90. In specific cases, the second clock enable extension circuit 184 may receive the second clock enable signal 218 for an amount of time associated with receiving and/or transmitting the secondary data 90 by the first secondary transmitter 78-1.

The second clock enable extension circuit 184 may receive the second clock enable signal 218. The second clock enable extension circuit 184 may output a second extended clock enable signal 220 (EXTENDED_CLK_EN2) to the third gater 180 based on receiving the second clock enable signal 218. The second clock enable extension circuit 184 may output the second extended clock enable signal 220 for an extended amount of time compared to the amount of time associated with receiving the second clock enable signal 218.

In some cases, the second clock enable extension circuit 184 may output the second extended clock enable signal 220 when receiving the second clock enable signal 218 and during an extended (or additional) time after the second clock enable signal 218 is received. The extended amount of time may be associated with additional time or additional number of clock cycles for the first primary receiver 70-1 to sample or clock-in the secondary data 90 after the first secondary transmitter 78-1 transmits the secondary data 90. In some cases, the extended amount of time may be associated with pipe cleaning the first primary receiver 70-1 after receiving the secondary data 90. In some embodiments, the extended amount of time for outputting the second extended clock enable signal 220 may be equal to, nearly equal to, or correspond to the extended amount of time for outputting the first extended clock enable signal 144 by the first clock enable extension circuit 106 discussed above.

As mentioned above, the second clock enable extension circuit 184 may also output the second data pattern 118 to the second serializer circuitry 186. In some embodiments, the second clock enable extension circuit 184 may output at least a portion of the second data pattern 118 during the additional time or the additional number of clock cycles. That is, in such embodiments, the second clock enable extension circuit 184 may output at least a portion of the second data pattern 118 when outputting the second extended clock enable signal 220 and when the second clock enable signal 218 is removed. Alternatively or additionally, the second clock enable extension circuit 184 may output at least a portion of the second data pattern 118 after the second extended clock enable signal 220 is removed.

As discussed above, the third gater 180 may receive the gated clock signal 88 and the second extended clock enable signal 220. The third gater 180 may output (e.g., forward, pass-through) the gated clock signal 88, as adjusted by the secondary clock adjustment circuit 178, to the third transmission amplifier 182 based on receiving the second extended clock enable signal 220. For example, the third gater 180 may output the gated clock signal 88 to the third transmission amplifier 182 while receiving the second extended clock enable signal 220. Moreover, the third gater 180 may not output the gated clock signal 88 when the second extended clock enable signal 220 is removed. In some embodiments, the third gater 180 may output the gated clock signal 88 by reducing a noise signal and/or undesired DC signals of the gated clock signal 88.

The third transmission amplifier 182 may output the gated clock signal 88 to the primary clock receiver 68. In particular, the third transmission amplifier 182 may output the gated clock signal 88 based on (e.g., during) the extended amount of time associated with the second extended clock enable signal 220. In some cases, the third transmission amplifier 182 may amplify a current and/or a voltage of the gated clock signal 88 to transmit an amplified gated clock signal 88 to the primary clock receiver 68. The primary clock receiver 68 may receive the gated clock signal 88 when activated. As mentioned above, the second pattern detection circuit 210 may activate the primary clock receiver 68 in response to detecting the first data pattern 114.

As such, the primary clock receiver 68 may receive the gated clock signal 88 in response to the first primary receiver 70-1, or any other primary receiver 70 (not shown for simplicity), receiving the first data pattern 114. In some cases, the first data pattern 114 may be indicative of a respective secondary data 90 being received subsequently. Alternatively or additionally, the first data pattern 114 may be associated with providing the gated clock signal 88 to the secondary circuit 62 in response to a synchronous or asynchronous request for the gated clock signal 88 from a secondary transmitter 78.

In the depicted embodiment, the primary clock receiver 68 may generate and output the adjusted feedback clock signal 92 and the gated feedback clock signal 94 based on receiving the gated clock signal 88 when activated. Alternatively or additionally, the primary clock receiver 68 may output the gated clock signal 88. As mentioned above, the primary clock receiver 68 may include the third reception amplifier 194, the second AC coupling circuit 196, the fourth gater 198, the second voltage converter 202, the second counter 204, and the second clock control circuit 206. In the depicted embodiment, the third transmission amplifier 182 of the secondary clock transmitter 76 may be coupled to the third reception amplifier 194 of the primary clock receiver 68 via a third bus 208.

In some cases, the first secondary transmitter 78-1 may output the first data pattern 114 at a time or near a time the secondary clock transmitter 76 outputs the gated clock signal 88. The second pattern detection circuit 210 may activate the third reception amplifier 194 at a time, near the time, or before the time the third reception amplifier 194 receives the gated clock signal 88. In specific cases, the third bus 208 and the fourth bus 216 may delay transporting the data and/or the gated clock signal 88 based on (e.g., at, after) a third time delay.

Moreover, the second pattern detection circuit 210, or pattern detection circuits of any other primary receiver 70 (not shown), may activate the primary clock receiver 68 based on receiving the first data pattern 114. In the depicted embodiment, the second pattern detection circuit 210 may activate the third reception amplifier 194, the second AC coupling circuit 196, the fourth gater 198, or any combination thereof. When activated, the third reception amplifier 194 may receive and provide the gated clock signal 88 to the second AC coupling circuit 196 and the second voltage converter 202. In some cases, the third reception amplifier 194 may amplify a current and/or a voltage of the gated clock signal 88 to output an amplified gated clock signal 88.

The second AC coupling circuit 196, the fourth gater 198, the second voltage converter 202, and the second counter 204 may form second clock settling circuitry 222. In some embodiments, the second AC coupling circuit 196 may include one or more capacitors. The second AC coupling circuit 196 may reduce undesired common-mode signals and/or undesired DC signals of the gated clock signal 88. If not compensated for, in some cases, the gated clock signal 88 may exhibit jitter and noise upon initial reception by the second AC coupling circuit 196. As such, the second clock settling circuitry 222 may disregard a number of clock cycles of the gated clock signal 88 upon initial reception of the gated clock signal 88, as will be appreciate.

Accordingly, the second clock settling circuitry 222 may improve the signal integrity of the received gated clock signal 88. For example, the number of the clock cycles may correspond to a settling time of the second AC coupling circuit 196. In some embodiments, the settling time of the second AC coupling circuit 196 may be equal to, nearly equal to, or correspond to the settling time of the first AC coupling circuit 150.

The second AC coupling circuit 196 may output the gated clock signal 88, as adjusted, to the fourth gater 198. In some cases, the second AC coupling circuit 196 may output a stabilized gated clock signal 88 based on (e.g., at or after) the settling time upon reception of the gated clock signal 88. For example, the second AC coupling circuit 196 may output one or more clock cycles with higher than a threshold voltage, phase, and/or frequency variation during the settling time and upon reception of the gated clock signal 88. Moreover, the second AC coupling circuit 196 may output a stabilized gated clock signal 88 after the settling time.

The second voltage converter 202 may adjust a voltage level (e.g., logic level) of the gated clock signal 88. In some embodiments, the second voltage converter 202 may receive the gated clock signal 88 with a first voltage level and output the gated clock signal 88 with a second voltage level. For example, the secondary clock transmitter 76 may transmit the gated clock signal 88 using the CML signaling based on voltage swings on a current level (e.g., constant current level). Moreover, the second voltage converter 202 may convert the gated clock signal 88 to a square wave signal with a voltage level of the primary clock receiver 68, such as a CMOS voltage level. Alternatively or additionally, the second voltage converter 202 may receive the gated clock signal 88 with a different voltage level or signaling and output the gated clock signal 88 with a different voltage level or signaling.

The second voltage converter 202 may output the gated clock signal 88, as adjusted, to the second counter 204. The second counter 204 may disregard a number of clock cycles of the gated clock signal 88 upon reception of the gated clock signal 88. The number of clock cycles may be associated with the settling time of the second AC coupling circuit 196.

In different cases, the secondary clock transmitter 76 may output the gated clock signal 88 with a different frequency. For example, the frequency of the gated clock signal 88 may be predetermined and/or programmable. Moreover, the frequency of the gated clock signal 88 may correspond to the settling time of the second AC coupling circuit 196. The number of clock cycles may be predetermined and/or programmable, for example, based on the frequency of the gated clock signal 88. As such, the second counter 204 may be programmable, dynamically or during manufacturing, to disregard a different number of clock cycles of the gated clock signal 88, upon reception of the gated clock signal 88, based on the frequency of the gated clock signal 88.

In any case, the second counter 204 may output a feedback clock enable signal 224 (FB_CLK_EN) after disregarding the number of clock cycles upon reception of the gated clock signal 88. The second counter 204 may remove the feedback clock enable signal 224 when the gated clock signal 88 is removed. As mentioned above, the secondary clock transmitter 76 may output the gated clock signal 88 based on the extended amount of time of the second extended clock enable signal 220. As such, in some cases, the second counter 204 may output the feedback clock enable signal 224 during a second time duration less than the extended amount of time of the second extended clock enable signal 220 by disregarding the number of clock cycles based on the settling time of the second AC coupling circuit 196.

The second counter 204 may output the feedback clock enable signal 224 to the fourth gater 198. As such, the fourth gater 198 may receive the gated clock signal 88 and the feedback clock enable signal 224. The second counter 204 may output the feedback clock enable signal 224 based on a fourth time delay compared to a reception time of the gated clock signal 88 by the primary clock receiver 68. The fourth time delay may be based on disregarding the number of clock cycles based on the settling time of the second AC coupling circuit 196.

The fourth gater 198 may output (e.g., forward, pass-through) a gated feedback clock signal 94 based on receiving the feedback clock enable signal 224. For example, the fourth gater 198 may output the gated feedback clock signal 94 while receiving the feedback clock enable signal 224. Moreover, the fourth gater 198 may not output the gated feedback clock signal 94 when the feedback clock enable signal 224 is removed. In some embodiments, the fourth gater 198 may output the gated feedback clock signal 94 by reducing a noise signal and/or undesired DC signals of the gated clock signal 88. As such, the second clock settling circuitry 222 may output the gated feedback clock signal 94 after the fourth time delay compared to the reception time of the gated clock signal 88.

The fourth gater 198 may output the gated feedback clock signal 94 to the second clock control circuit 206 and the secondary clock transmitter 76. In the depicted embodiment, the primary clock adjustment circuit 108 of the primary clock transmitter 64 may receive the gated feedback clock signal 94. In some embodiments, the primary clock adjustment circuit 108 may adjust a phase of the clock signal 82, generate in-phase and quadrature signals based on the clock signal 82, and/or adjust the frequency of the clock signal 82 based on the gated feedback clock signal 94. As such, the primary circuit 60 may be synchronized with the secondary circuit 62.

In some embodiments, the second clock control circuit 206 may include a digital clock control circuit, a digitally controlled delay line, a phase interpolator, a gater, or any combination thereof, among other things. The second clock control circuit 206 may adjust a phase of the gated feedback clock signal 94, generate in-phase and quadrature signals based on the gated feedback clock signal 94, and/or adjust the frequency of the gated feedback clock signal 94. The second clock control circuit 206 may generate the adjusted feedback clock signal 92. In the depicted embodiment, the second clock control circuit 206 may output the adjusted feedback clock signal 92 to the second phase correction circuit 214. Alternatively or additionally, the second clock control circuit 206 may output the adjusted feedback clock signal 92 to any other viable circuitry.

As discussed above, the secondary clock transmitter 76 may output the gated clock signal 88 based on the extended amount of time of the second extended clock enable signal 220. Moreover, the second clock enable extension circuit 184 may output the second extended clock enable signal 220 when receiving the second clock enable signal 218 and during an extended (or additional) time after the second clock enable signal 218 is received. In some embodiments, the extended amount of time may include at least a portion of the third time delay associated with the third bus 208 and the fourth bus 216 transporting the data and/or the gated clock signal 88.

Additionally or alternatively, the extended amount of time may include at least a portion of the fourth time delay associated with stabilizing the gated clock signal 88 based on the settling time of the second AC coupling circuit 196. Additionally or alternatively, the extended amount of time may include at least a portion of the additional time or additional number of clock cycles for the first primary receiver 70-1 to sample or clock-in the secondary data 90 after the first secondary transmitter 78-1 transmits the secondary data 90. For example, the first primary receiver 70-1 may clock-in or sample the secondary data 90 using the clock cycles received during reception of the secondary data 90 and additional clock cycles after receiving the entirety of the secondary data 90.

Referring back to the first primary receiver 70-1, the fourth reception amplifier 209 may receive and provide (e.g., forward, pass-through) the secondary data 90 followed by the second data pattern 118. As mentioned above, the secondary data 90 may include the first data pattern 114 and the second synchronization data and/or payload 192. In some cases, the fourth reception amplifier 209 may amplify a current and/or a voltage of the input signals to output amplified secondary data 90 and/or amplified second data pattern 118.

The second deserializer and sampler circuitry 212 may receive the secondary data 90 followed by the second data pattern 118. In some embodiments, the second deserializer and sampler circuitry 212 may include circuitry to receive the secondary data 90 and/or the second data pattern 118 in serial form, convert the serial secondary data 90 and/or the serial second data pattern 118 to parallel form, and output the secondary data 90 and/or the second data pattern 118 in parallel form. In some embodiments, the second deserializer and sampler circuitry 212 may include circuitry to sample or clock-in the secondary data 90 and the second data pattern 118.

The first primary receiver 70-1 may detect the secondary data transmission period based on the first data pattern 114 and the second data pattern 118. For example, the first primary receiver 70-1 may transition to an active mode based on receiving the first data pattern 114. The second deserializer and sampler circuitry 212 may detect or generate a reception data edge signal 226 (e.g., RX_EDGE) and a reception payload 228 (e.g., RX_DATA) based on receiving the secondary data 90 and/or the second data pattern 118. The reception data edge signal 226 may have an oscillation pattern (e.g., signal edges) based on a frequency and/or phases of the secondary data 90 and/or the second data pattern 118. In some embodiments, the reception data edge signal 226 may have a frequency equal to, nearly equal to, or corresponding to the transmission data edge signal 166 discussed above.

The second deserializer and sampler circuitry 212 may output the reception data edge signal 226 and the reception payload 228 to the second CDR circuit 215. In some embodiments, the second CDR circuit 215 may generate second clock recovery signal 230 based on the reception data edge signal 226 and the reception payload 228. The second clock recovery signal 230 may include a clock signal having a frequency and/or phases corresponding to the frequency and/or phases of the secondary data 90 and/or the second data pattern 118. The second phase correction circuit 214 may receive the second clock recovery signal 230 from the second CDR circuit 215. Moreover, the second phase correction circuit 214 may receive the adjusted feedback clock signal 92 from the second clock control circuit 206.

The second phase correction circuit 214 may include a digital clock control circuit, a digitally controlled delay line, a phase interpolator, a gater, or any combination thereof, among other things. The second phase correction circuit 214 may adjust a phase of the adjusted feedback clock signal 92, generate in-phase and quadrature signals of the adjusted feedback clock signal 92, and/or adjust the frequency of the adjusted feedback clock signal 92 based on the second clock recovery signal 230. The second phase correction circuit 214 may provide the adjusted feedback clock signal 92, as adjusted, to the second deserializer and sampler circuitry 212.

Accordingly, the second deserializer and sampler circuitry 212 may sample or clock-in the secondary data 90 and the second data pattern 118 based on the adjusted feedback clock signal 92, as adjusted based on a frequency and/or phase of previously received secondary data 90 and/or previously received second data pattern 118. In some cases, the second deserializer and sampler circuitry 212 may detect the reception payload 228 by sampling or clocking-in the secondary data 90 based on the adjusted feedback clock signal 92. In some embodiments, the second deserializer and sampler circuitry 212 may detect the reception payload 228 based on instructions received with the synchronization data of the second synchronization data and/or payload 192.

The reception payload 228 may include data indicative of an operation, data for display on the display 12 of the electronic device 10, and/or data for storage on the memory 20 and/or the storage devices 22, among other possibilities. In the depicted embodiment, primary registers 232 of the secondary circuit 62 may store the reception payload 228. For example, the memory 20 and/or the storage devices 22 of the electronic device 10 may include the primary registers 232.

The second deserializer and sampler circuitry 212 may receive the second data pattern 118 after the secondary data 90. As mentioned above, the second data pattern 118 may be indicative of a termination of the secondary data transmission period. For example, the second deserializer and sampler circuitry 212 may detect or generate the reception payload 228 based on receiving the secondary data 90 during the secondary data transmission period. Moreover, the second deserializer and sampler circuitry 212 may become idle based on receiving the second data pattern 118. In some cases, the second pattern detection circuit 210 and/or the second deserializer and sampler circuitry 212 may snoop for a subsequent first data pattern 114 and/or a subsequent second synchronization data and/or payload 192 when in idle mode. Moreover, the second deserializer and sampler circuitry 212 may become activated based on receiving the subsequent first data pattern 114 and/or the subsequent second synchronization data and/or payload 192 when in the idle mode.

FIG. 8 is an example timing diagram 240 of the transceiver 28 when the first primary transmitter 66-1 transmits the primary data 84, according to embodiments of the present disclosure. The first primary transmitter 66-1 may output the primary data 84 and the second data pattern 118. In particular, the first primary transmitter 66-1 may output the first data pattern 114 between a time T1 and a time T4.

Before the time T1, the first primary transmitter 66-1 may output the second data pattern 118 or any other data pattern. For example, the first primary transmitter 66-1 may output an indication of an idle mode before the time T1. The first secondary receiver 74-1 may receive the first data pattern 114 based on (e.g., at, after) the first time delay at the time T2. As mentioned above, the first bus 136 and/or the second bus 160 may transport the data based on the first time delay. Moreover, the first secondary receiver 74-1 may receive the first data pattern 114 synchronously or asynchronously.

The first clock enable signal 142 and the first extended clock enable signal 144 may transition to a voltage level (e.g., logic high, logic low) at the time T1. As such, the primary clock transmitter 64 may output the clock signal 82 at the time T1. The secondary clock receiver 72 may receive the clock signal 82 based on (e.g., at, after) the first time delay at the time T2. The secondary clock receiver 72 may generate the adjusted clock signal 86 at a time T3 and after the second time delay. As mentioned above, the second time delay may be associated with the settling time of the clock signal 82 at the secondary clock receiver 72.

As shown in the depicted embodiment, the secondary clock receiver 72 may generate the adjusted clock signal 86 at the time T3 before the first secondary receiver 74-1 receiving the first synchronization data and/or payload 116 at the time T5. Subsequently, the first primary transmitter 66-1 may output the first synchronization data and/or payload 116 between times T4 and T6. The first secondary receiver 74-1 may receive the first synchronization data and/or payload 116 between times T5 and T7 based on (e.g., at, after) the first time delay.

As such, the first secondary receiver 74-1 may clock-in and/or sample the first synchronization data and/or payload 116 using the adjusted clock signal 86. Accordingly, in some embodiments, the secondary circuit 62 may not include a designated clock circuit for clocking-in and/or sampling the first synchronization data and/or payload 116. Moreover, the first secondary receiver 74-1 may output the transmission payload 168 based on clocking-in and/or sampling the first synchronization data and/or payload 116.

In the depicted embodiment, the first extended clock enable signal 144 may have an extended amount of time between the time T1 and the time T8 compared to the amount of time associated with the first clock enable signal 142 between the time T1 and the time T6. As mentioned above, in some cases, the first secondary receiver 74-1 may clock-in or sample the primary data 84 using the clock cycles received during reception of the primary data 84 and additional clock cycles after receiving the primary data 84. Moreover, the first clock enable extension circuit 106 may output the first extended clock enable signal 144 when receiving the first clock enable signal 142 from the clock circuit 80 and during an extended (or additional) time after the first clock enable signal 142 is received. As such, the first extended clock enable signal 144 may be provided during the extended (or additional) time after the first clock enable signal 142 is received, illustrated between T6 and T8, for pipe cleaning of the first secondary receiver 74-1.

The primary clock transmitter 64 may remove the clock signal 82 at the time T8. The clock signal 82 may be removed from the first secondary receiver 74-1 at a time T9. Fr example, the first secondary receiver 74-1 may output the transmission payload 168 based on clocking-in and/or sampling the first synchronization data and/or payload 116 between the time T6 and the time T7 before the clock signal 82 may be removed.

It should be appreciated that in some embodiments, the second primary transmitter 66-2 and the N^{th} primary transmitter 66-N may transmit respective primary data with a timing equal to or nearly equal to the timing of the primary data 84. Moreover, it should be appreciated that in some embodiments, the second secondary receiver 74-2 and the N^{th} secondary receiver 74-N may receive the respective primary data with a timing equal to or nearly equal to the timing of the primary data 84. Moreover, it should be appreciated that the timing diagram 240 is provided by the way of example and the transceiver 28 may perform the operations based on a different timing diagram. Furthermore, although certain data patterns and/or signals are discussed, it should be appreciated that the transceiver 28 may also operate using alternative or additional data patterns and/or signals.

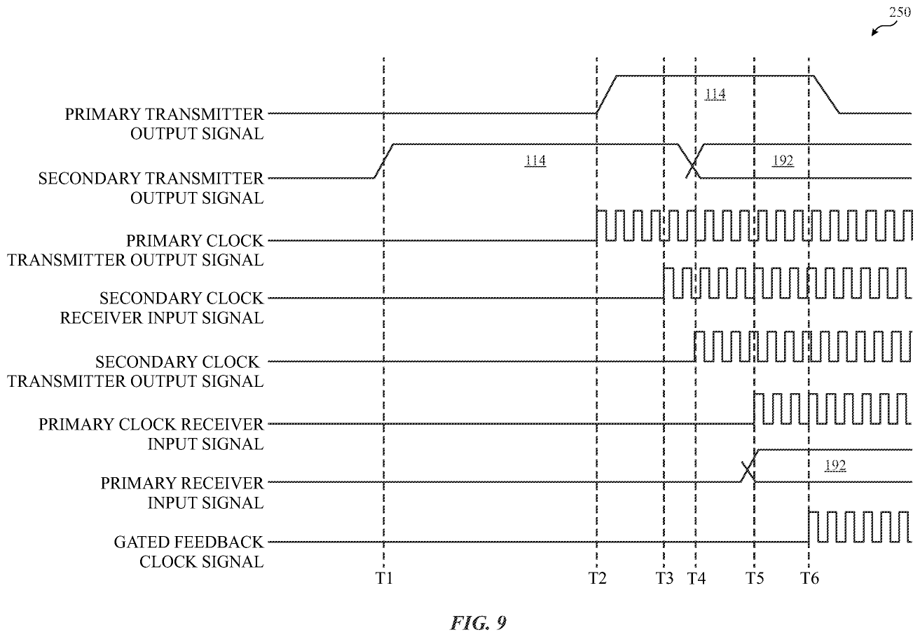

FIG. 9 is an example timing diagram 250 of the first secondary transmitter 78-1 transmitting the secondary data 90 based on requesting for the clock signal 82, according to embodiments of the present disclosure. Before a time T1, the first primary transmitter 66-1 may output the second data pattern 118 or any other data pattern. For example, the first primary transmitter 66-1 may output an indication of the idle mode before the time T1. In some cases, the transceiver 28 may be in a stall mode or the idle mode.

At the time T1, the first secondary transmitter 78-1 may output the first data pattern requesting for the clock signal 82. The first primary receiver 70-1 of the primary circuit 60 may receive the request for the clock signal 82. The primary clock transmitter 64 of the primary circuit 60 may output the clock signal 82 at a time T2 in response to the request. In some embodiments, the first primary transmitter 66-1 of the primary circuit 60 may output the first data pattern 114 at the time T2 in response to the request.

The secondary clock receiver 72 may receive the clock signal 82 at a time T3 based on the first time delay. Moreover, the secondary clock receiver 72 may output the gated clock signal 88 at a time T4 based on the second time delay. As such, the first secondary clock transmitter 76-1 may output the second synchronization data and/or payload 192 with the gated clock signal 88 at the time T4. For example, the first secondary clock transmitter 76-1 may output the second synchronization data and/or payload 192 based on using the gated clock signal 88. Accordingly, in some embodiments, the secondary circuit 62 may not include a designated clock circuit for clocking-out and/or transmitting the second synchronization data and/or payload 192.

In some embodiments, the first primary clock receiver 68-1 may receive the gated clock signal 88 at a time T5. Moreover, the first primary receiver 70-1 may receive the second synchronization data and/or payload 192 at the time T5. As such, the secondary circuit 62 may output the second synchronization data and/or payload 192 to the primary circuit 60 using the clock signal 82 of the primary circuit 60. In some embodiments, the primary clock receiver 68 may output the gated feedback clock signal 94 to the primary clock transmitter 64 at a time T6. As discussed above, the primary clock transmitter 64 may adjust a phase of the clock signal 82, generate in-phase and quadrature signals based on the clock signal 82, and/or adjust the frequency of the clock signal 82 based on the gated feedback clock signal 94. As such, the primary circuit 60 may be synchronized with the secondary circuit 62.

In alternative or additional cases, the first secondary transmitter 78-1 may request for the clock signal 82 when the secondary clock receiver 72 and/or the secondary clock transmitter 76-1 may be receiving the clock signal 82 and/or the gated clock signal 88. In such cases, the first secondary transmitter 78-1 may output the secondary data 90 when receiving the clock signal 82 and/or the gated clock signal 88. In specific cases, the clock signal 82 and/or the gated clock signal 88 may be removed when the first secondary transmitter 78-1 maybe transmitting the secondary data 90. In such cases, the first secondary transmitter 78-1 may output the first data pattern 114 requesting for the clock signal 82 and/or the gated clock signal 88. Accordingly, the first secondary transmitter 78-1 may output the first synchronization data and/or payload 116 when receiving the clock signal 82 and/or the gated clock signal 88 in response to transmitting the first data pattern 114.

It should be appreciated that in some embodiments, the second secondary transmitter 78-2 and the N^{th} secondary transmitter 78-N may transmit the respective secondary data with a timing equal to or nearly equal to the timing of the secondary data 90. Moreover, it should be appreciated that the timing diagram 250 is provided by the way of example and the transceiver 28 may perform the operations based on a different timing diagram. Furthermore, although certain data patterns and/or signals are discussed, it should be appreciated that the transceiver 28 may also operate using alternative or additional data patterns and/or signals.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

What is claimed is:

1. An electronic device comprising:
a clock circuit configured to generate a clock signal;
a primary clock transmitter coupled to the clock circuit, wherein the primary clock transmitter is configured to output the clock signal during a data transmission period and during an extended time after the data transmission period;
a primary transmitter configured to output primary data during the data transmission period;
a secondary clock receiver coupled to the primary clock transmitter, wherein the secondary clock receiver is configured to receive and output the clock signal; and
a secondary receiver coupled to the primary transmitter and the secondary clock receiver, wherein the secondary receiver is configured to receive the primary data from the primary transmitter, and receive the clock signal from the primary clock transmitter, wherein the secondary receiver is configured to clock-in or sample the primary data based on the clock signal.

2. The electronic device of claim 1, wherein the clock circuit is configured to generate a clock enable signal indicative of the data transmission period, and wherein the primary clock transmitter is configured to output the clock signal during the data transmission period based on receiving the clock enable signal and during the extended time after the clock enable signal is removed.

3. The electronic device of claim 1, wherein the secondary clock receiver is configured to receive the clock signal during a time corresponding to the data transmission period and the extended time, and output the clock signal during a time corresponding to at least a portion of the data transmission period and the extended time.

4. The electronic device of claim 1, wherein the secondary receiver is configured to clock-in or sample the primary data based on the clock signal during a time corresponding to at least a portion of the data transmission period and the extended time.

5. The electronic device of claim 1, wherein the primary clock transmitter is coupled to the primary transmitter, wherein the primary clock transmitter is configured to output an idle mode data pattern, and wherein the primary transmitter is configured to output the idle mode data pattern to the secondary receiver subsequent to outputting the primary data.

6. The electronic device of claim 5, wherein the secondary receiver is configured to deactivate the secondary clock receiver based on the idle mode data pattern.

7. The electronic device of claim 1, wherein the secondary clock receiver is configured to receive the clock signal when activated, wherein the secondary receiver is configured to activate the secondary clock receiver in response to the primary data.

8. The electronic device of claim 1, wherein the secondary receiver comprises an alternating current coupling circuit, wherein the alternating current coupling circuit is configured to input the clock signal, and wherein the secondary clock receiver is configured to output the received clock signal with a time delay by disregarding one or more initial clock cycles of the received clock signal based on a settling time of the clock signal at the alternating current coupling circuit.

9. The electronic device of claim 1, comprising a secondary clock transmitter and a secondary transmitter, wherein the secondary clock transmitter is coupled to the secondary clock receiver, wherein the secondary clock transmitter is configured to receive the clock signal from the secondary clock receiver, wherein the secondary clock transmitter is configured to output the clock signal, and wherein the secondary transmitter is configured to output secondary data.

10. The electronic device of claim 9, comprising:
a primary clock receiver coupled to the secondary clock transmitter, wherein the primary clock receiver is configured to receive the clock signal; and
a primary receiver coupled to the secondary transmitter and the primary clock receiver, wherein the primary receiver is configured to receive the secondary data and the clock signal, wherein the secondary receiver is configured to clock-in or sample the secondary data based on the clock signal.

11. An electronic system comprising:
a clock circuit configured to generate a clock signal;
a primary circuit coupled to the clock circuit, wherein the primary circuit is configured to output primary data during a data transmission period, and output the clock signal during the data transmission period and an extended time after the data transmission period;
a secondary circuit coupled to the primary circuit, wherein the secondary circuit is configured to receive the primary data and the clock signal, wherein the secondary circuit is configured to clock-in or sample the primary data based on the clock signal during at least a portion of the data transmission period and the extended time.

12. The electronic system of claim 11, wherein the extended time is associated with additional clocking-in or sampling time of the secondary circuit when receiving the primary data based on the clock signal.

13. The electronic system of claim 11, wherein the clock circuit is configured to generate a clock enable signal corresponding to the data transmission period, wherein the primary circuit comprises clock extension circuitry configured to generate an extended clock enable signal based on the clock enable signal, wherein the extended clock enable signal corresponds to the data transmission period and the extended time after the data transmission period.

14. The electronic system of claim 11, wherein the secondary circuit comprises clock settling circuitry configured to disregard one or more initial clock cycles of the received clock signal based on a settling time of the secondary circuit.

15. The electronic system of claim 11, comprising one or more of a display, input devices, input/output ports, processor core complex, a memory, storage devices, a network interface, a power supply, antennas, or any combination thereof, wherein the primary circuit or the secondary circuit may include at least a portion of the display, the input devices, the input/output ports, the processor core complex, the memory, the storage devices, the network interface, the power supply, the antennas, or any combination thereof.

16. The electronic system of claim 11, wherein the secondary circuit is configured to output secondary data during a second data transmission period, and output the clock signal during the second data transmission period and a second extended time after the second data transmission period, and wherein the primary circuit is configured to receive the secondary data and the clock signal.

17. An electronic system comprising:
a clock circuit configured to generate a clock signal, and configured to generate a clock enable signal;
a primary clock transmitter coupled to the clock circuit, wherein the primary clock transmitter is configured to output the clock signal;
a first primary transmitter configured to output first data;
a second primary transmitter configured to output second data; and
a secondary clock receiver coupled to the primary clock transmitter, wherein the secondary clock receiver is configured to receive the clock signal during a data transmission period associated with the first primary transmitter outputting the first data or the second primary transmitter outputting the second data and during an extended time after the data transmission period, and transition to an idle mode in response to an indication of the first primary transmitter and the second primary transmitter transitioning to the idle mode and expiration of the data transmission period and the extended time.

18. The electronic system of claim 17, comprising a first secondary receiver coupled to the first primary transmitter and the secondary clock receiver, wherein the first secondary receiver is configured to receive the first data and the clock signal, wherein the first secondary receiver is configured to clock-in or sample the first data based on the clock signal.

19. The electronic system of claim 17, comprising a second secondary receiver coupled to the second primary transmitter and the secondary clock receiver, wherein the second secondary receiver is configured to receive the second data and the clock signal, wherein the second secondary receiver is configured to clock-in or sample the second data based on the clock signal.

20. The electronic system of claim 17, comprising:
a secondary clock transmitter coupled to the secondary clock receiver, wherein the secondary clock transmitter is configured to output the clock signal;
a first secondary transmitter configured to output third data;
a second secondary transmitter configured to output fourth data; and
a primary clock receiver coupled to the secondary clock transmitter, wherein the primary clock receiver is configured to receive the clock signal in response to the first secondary transmitter outputting the third data or the second secondary transmitter outputting the fourth data, and transition to the idle mode in response to an indication of the first secondary transmitter and the second secondary transmitter transitioning to the idle mode.
